(19) United States
(12) Patent Application Publication
(10) Pub. No.: US 2016/0176240 A1
(43) Pub. Date: Jun. 23, 2016

(54) REDUCED WEIGHT AIRCRAFT TIRE

(71) Applicant: The Goodyear Tire & Rubber Company, Akron, OH (US)

(72) Inventor: Kiyoshi Ueyoko, Copley, OH (US)

(21) Appl. No.: 14/578,997

(22) Filed: Dec. 22, 2014

(51) Int. Cl. B60C 15/00; B60C 9/02; B60C 9/00

(52) U.S. Cl. CPC B60C 15/0009; B60C 9/0042; B60C 9/02

(57) ABSTRACT

A pneumatic tire is disclosed having a carcass and a belt reinforcing structure, an inner liner, the carcass comprising at least two inner plies which are wound around a annular bead member from axially inside of the annular bead member toward axially outside thereof and extends radially outward towards the crown to form respective turnup portions; at least one outer carcass ply that extends radially inward from the crown and axially outward of the annular bead member and being partially wrapped around the bead terminating in an ending; a barrier ply located between the inner liner and the axially innermost inner ply, the barrier ply having a first end which terminates in the shoulder area of the tire and a second end that has a terminal end positioned under the outer carcass ply.

### FIELD OF THE INVENTION

This invention relates to pneumatic tires having a carcass and a belt reinforcing structure, more particularly to high speed heavy load tires such as those used on aircraft.

### BACKGROUND OF THE INVENTION

The radial carcass reinforcements of aircraft tires generally comprise several plies of textile cords, which are anchored to at least one annular bead member. A first group of reinforcing plies are generally wound around said annular bead member from the inside to the outside, forming turn-ups, the respective ends of which are radially spaced from the axis of rotation of the tire. The second group of plies are generally wound around the annular bead member from the outside to the inside of the tire.

Aircraft tires typically use numerous layers of ply which can significantly contribute to the tire weight. The numerous layers of ply may result in bead durability issues. It is thus desired to provide a lightweight efficient tire structure having improved bead durability. It is a further desired to provide an improved bead structure wherein the use of inside turn-up plies and outside turndown plies and their respective locations are optimized. Thus an improved aircraft tire is needed, which is capable of meeting high speed, high load and with reduced weight.

### SUMMARY OF THE INVENTION

A pneumatic tire is disclosed having a carcass and a belt reinforcing structure, an inner liner, the carcass comprising at least two inner plies which are wound around a annular bead member from axially inside of the annular bead member toward axially outside thereof and extends radially outward towards the crown to form respective turnup portions; at least one outer carcass ply that extends radially inward from the crown and axially outward of the annular bead member and being partially wrapped around the bead terminating in an ending; a barrier ply located between the inner liner and the axially innermost inner ply, the barrier ply having a first end which terminates in the shoulder area of the tire and a second end that has a terminal end positioned under the outer carcass ply.

### DEFINITIONS

“100 percent Modulus” means the force in mega-pascals (MPa) required to produce 100 percent elongation (e.g., stretch to two times original length).

“300 percent Modulus” or “M300 modulus” means the force in mega-pascals (MPa) required to produce 300 percent elongation (e.g., stretch to four times original length).

“Apex” means an elastomeric filler located radially above the bead core and between the plies and the turnup ply or axially outside the turnup ply.

“Annular” means formed like a ring.

“Axial” and “axially” are used herein to refer to lines or directions that are parallel to the axis of rotation of the tire.

“Bead” means that part of the tire comprising an annular tensile member wrapped by ply cords and shaped, with or without other reinforcement elements such as flippers, chippers, apexes, toe guards and chafers, to fit the design rim.

“Belt structure” means at least two annular layers or plies of parallel cords, woven or unwoven, underlying the tread, unanchored to the bead, and having cords inclined respect to the equatorial plane of the tire. The belt structure may also include plies of parallel cords inclined at relatively low angles, acting as restricting layers.

“Carcass” means the tire structure apart from the belt structure, tread, undertread, and sidewall rubber over the plies, but including the beads.

“Casing” means the carcass, belt structure, beads, sidewalls and all other components of the tire excepting the tread and undertread (e.g., the whole tire).

“Chafer” refers to a narrow strip of material placed around the exterior of the bead to protect bead structures from the rim, distribute flexing radially above the rim, and to better seal the tire to the rim.

“Chipper” refers to a narrow band of fabric or steel cords located in the bead area whose function is to reinforce the bead area and stabilize the radially inwardmost part of the sidewall.

“Circumferential” means lines or directions extending along the perimeter of the surface of the annular tire parallel to the Equatorial Plane (EP) and perpendicular to the axial direction; it can also refer to the direction of the sets of adjacent circular curves whose radii define the axial curvature of the tread, as viewed in cross section.

“Cord” means one of the reinforcement strands of which the reinforcement structures of the tire are comprised.

“Cord angle” means the acute angle, left or right in a plan view of the tire, formed by a cord with respect to the equatorial plane. The “cord angle” is measured in a cured but uninflated tire.

“Crown” means that portion of the tire within the width limits of the tire tread.

“Denier” means the weight in grams per 9000 meters (unit for expressing linear density). Dtex means the weight in grams per 10,000 meters.

“Density” means weight per unit length.

“Elastomer” means a resilient material capable of recovering size and shape after deformation.

“Equatorial plane (EP)” means the plane perpendicular to the tire's axis of rotation and passing through the center of its tread; or the plane containing the circumferential centerline of the tread.

“Fabric” means a network of essentially unidirectionally extending cords, which may be twisted, and which in turn are composed of a plurality of a multiplicity of filaments (which may also be twisted) of a high modulus material.

“Fiber” is a unit of matter, either natural or man-made that forms the basic element of filaments. Characterized by having a length at least 100 times its diameter or width.

“Filament count” means the number of filaments that make up a yarn. Example: 1000 denier polyester has approximately 190 filaments.

“Flipper” refers to a reinforcing fabric around the bead wire for strength and to tie the bead wire in the tire body.

“Gauge” refers generally to a measurement, and specifically to a thickness measurement.

“Inner” means toward the inside of the tire and “outer” means toward its exterior.

“Innerliner” means the layer or layers of elastomer or other material that form the inside surface of a tubeless tire and that contain the inflating fluid within the tire.

“Lateral” means an axial direction.

“Load Range” means load and inflation limits for a given tire used in a specific type of service as defined by tables in The Tire and Rim Association, Inc.

“Normal Load” means the specific design inflation pressure and load assigned by the appropriate standards organization for the service condition for the tire.

“Ply” means a cord-reinforced layer of rubber-coated radially deployed or otherwise parallel cords.

“Radial” and “radially” are used to mean directions radially toward or away from the axis of rotation of the tire.

“Radial Ply Structure” means the one or more carcass plies or which at least one ply has reinforcing cords oriented at an angle of between 65° and 90° with respect to the equatorial plane of the tire.

“Radial Ply Tire” means a belted or circumferentially-restricted pneumatic tire in which at least one ply has cords which extend from bead to bead are laid at cord angles between 65° and 90° with respect to the equatorial plane of the tire.

“Section Height” means the radial distance from the nominal rim diameter to the outer diameter of the tire at its equatorial plane.

“Section Width” means the maximum linear distance parallel to the axis of the tire and between the exterior of its sidewalls when and after it has been inflated at normal pressure for 24 hours, but unloaded, excluding elevations of the sidewalls due to labeling, decoration or protective bands.

“Sidewall” means that portion of a tire between the tread and the bead.

“Stiffness ratio” means the value of a control belt structure stiffness divided by the value of another belt structure stiffness when the values are determined by a fixed three point bending test having both ends of the cord supported and flexed by a load centered between the fixed ends.

“Tread” means a molded rubber component which, when bonded to a tire casing, includes that portion of the tire that comes into contact with the road when the tire is normally inflated and under normal load.

“Tread width” means the arc length of the tread surface in a plane including the axis of rotation of the tire.

“Turnup end” means the portion of a carcass ply that turns upward (i.e., radially outward) from the beads about which the ply is wrapped.

### BRIEF DESCRIPTION OF THE DRAWINGS

The invention will be described by way of example and with reference to the accompanying drawings in which:

FIG. 1 is a schematic cross-sectional view of a first embodiment of one-half of a tire according to the invention; and

FIG. 2 is a close up cross-sectional view of the bead area of the tire of FIG. 1.

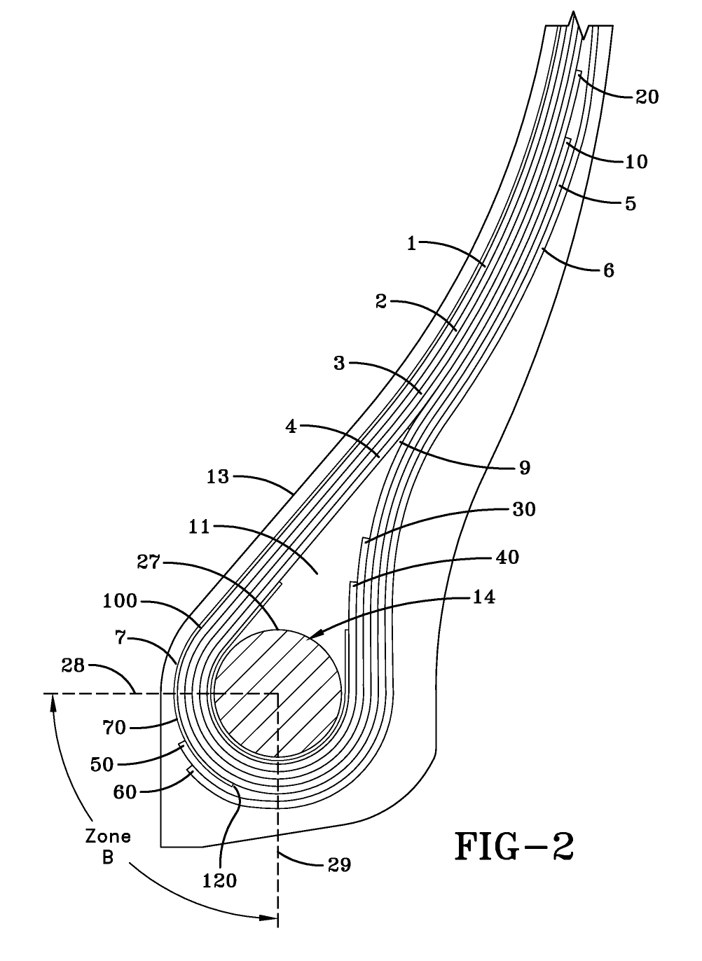

### DETAILED DESCRIPTION OF THE INVENTION

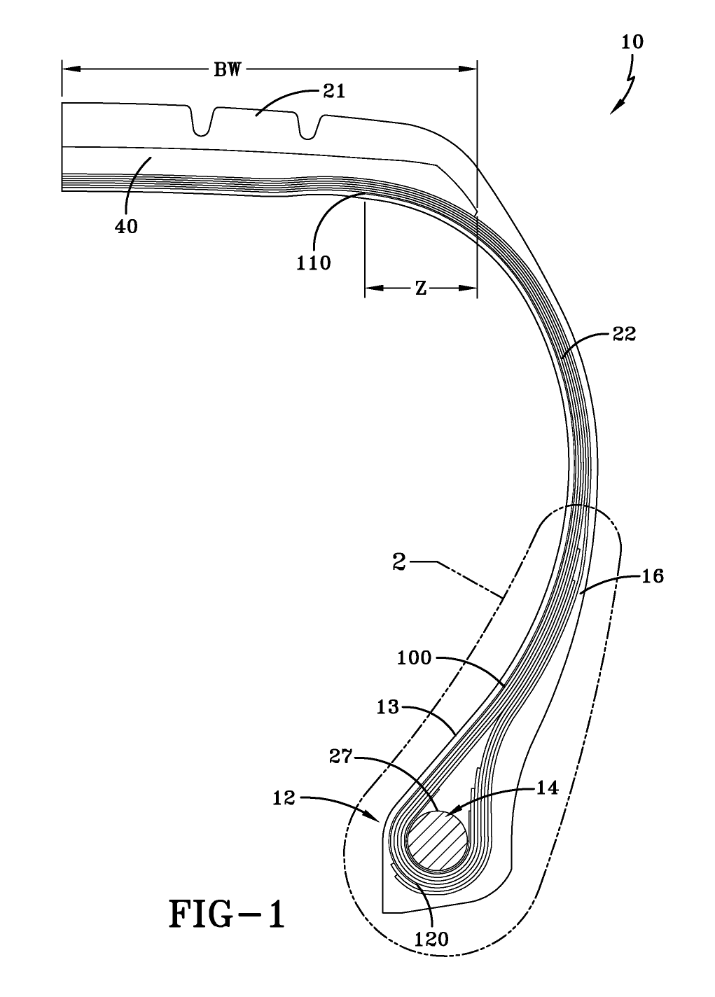

FIG. 1 illustrates a cross-sectional view of one half of a radial aircraft tire 10 of the present invention. The tire is symmetrical about the mid-circumferential plane so that only one half is illustrated. As shown, the aircraft tire comprises a pair of bead portions 12 each containing an annular bead member 14 embedded therein. A person skilled in the art may appreciate that other annular bead members may also be utilized.

The aircraft tire further comprises a sidewall portion 16 extending substantially outward from each of the bead portions 12 in the radial direction of the tire, and a tread 21 extending between the radially outer ends of the sidewall portions 16. Furthermore, the tire 10 is reinforced with a carcass 22 toroidally extending from one of the bead portions 12 to the other bead portion 12. An air impervious inner liner 13 is located on the inner surface of the carcass 22. The carcass 22 is comprised of at least two axially inner carcass plies 1,2, and more preferably an additional two axially inner carcass plies 3,4 and outer carcass down plies 5,6. Among these carcass plies, typically four axially inner plies 1,2,3,4 extend radially inward from the crown towards the bead area. The axially inner plies 1,2,3,4 are wound around the annular bead member 14 from axially inside of the annular bead member toward axially outside thereof and extends radially outward towards the crown to form respective turnup portions 10, 20, 30, 40. Preferably, the ply adjacent the bead 4 has a turnup 40 that is located between the bead outer radial surface 27 and the outer radial end or tip 9 of an apex 11.

The carcass further comprises at least two axially outer plies 5,6 which extend radially inward from the crown and are axially outward of the annular bead member 14 along the outside of the turnup portion 10 of the inner carcass ply 1. The two outer carcass plies 5,6 extend down from the crown and further extend axially outward and are wrapped around the bead terminating in endings 50, 60, respectively. Preferably, one of the endings 50, 60 overlap with the one or more inner plies and has a terminal end in zone B. Preferably, two of the endings 50, 60 overlap with the one or more inner plies and have a terminal end in zone B. Zone B is defined by a first axial plane 28 that intersects the bead core center point, and wherein the first plane 28 is parallel to the tire axis of rotation. Zone B is further defined by a second plane 29 that is perpendicular to the first axial plane 28 and intersects the bead core center. Zone B is further defined as being radially inward of the first axial plane 28 and axially inward of the second plane 29.

Each of these carcass plies 1-6 may comprise any suitable cord, typically nylon cords such as nylon-6,6 cords extending substantially perpendicular to an equatorial plane EP of the tire (i.e. extending in the radial direction of the tire). Preferably the nylon cords have an 1890 denier/2/2 or 1890 denier/3 construction. One or more of the carcass plies may also comprise an aramid and nylon cord structure, for example, a hybrid cord, a high energy cord or a merged cord. Examples of suitable cords are described in U.S. Pat. No. 4,893,665, U.S. Pat. No. 4,155,394 or U.S. Pat. No. 6,799,618. One or more of the carcass plies have reinforcements that make an angle with respect to the equatorial plane in the range of 70-90 degrees, more preferably 80-90, and most preferably 88 degrees.

Located between the inner liner 13 and the axially innermost carcass ply 1 is a barrier ply layer 100. The barrier ply layer 100 functions to ensure even spacing among the inner ply cords. The barrier ply layer has a first end 110 that terminates in the shoulder area, and does not extend under the crown. Preferably the first end 110 terminates axially inward of the narrowest belt axially outer end. More preferably, the first end 110 terminates axially inward an axial distance Z as measured from the axially outermost belt edge. Z ranges from (0.1 to 0.25)*Bw, wherein Bw is the maximum belt width. The barrier ply has a second end 120 that is tucked under down ply ending 50, and is located between the axially innermost ply 1 and the down ply ending 50. Thus in one embodiment, the barrier ply does not extend under the crown portion of the tire. However, in an alternate embodiment, the barrier ply may extend under the crown from one bead to the other. The barrier ply has a plurality of parallel reinforcements that make an angle with respect to the equatorial plane in the range of 70-90 degrees, more preferably 80-88 degrees, and most preferably 84-88 degrees. The cord strength of the barrier layer reinforcements is less than the carcass plies. The barrier ply may have a thickness less than or equal to the carcass plies. The barrier ply 100 functions to minimize non-uniformity of the ply cord spacing and inner ply cord distortion during the shaping process.

Variations of the present invention are possible in light of the description as provided herein. While certain representative embodiments and details have been shown for the purpose of illustrating the subject inventions, it will be apparent to those skilled in the art that various changes and modifications can be made without departing from the scope of the subject inventions.

What is claimed is:

1. A pneumatic tire having a carcass and a belt reinforcing structure, an inner liner, the carcass comprising at least two inner plies which are wound around a annular bead member from axially inside of the annular bead member toward axially outside thereof and extends radially outward towards the crown to form respective turnup portions; at least one outer carcass ply that extends radially inward from the crown and axially outward of the annular bead member and being partially wrapped around the bead terminating in an ending; and a barrier ply located between the inner liner and the axially innermost inner ply.

2. The pneumatic tire of claim 1 wherein the barrier ply has a first end which terminates in the shoulder area of the tire.

3. The pneumatic tire of claim 1 wherein the barrier ply has a first end which terminates axially inward of the outermost belt edge.

4. The pneumatic tire of claim 2 wherein the barrier ply has a second end that has a terminal end positioned between the axially innermost inner ply and the terminal end of the outer carcass ply.

5. The tire of claim 1 wherein the barrier ply has a plurality of parallel reinforcements that make an angle with respect to the equatorial plane in the range of 70-90 degrees.

6. The tire of claim 1 wherein the barrier ply has a plurality of parallel reinforcements that make an angle with respect to the equatorial plane in the range of 80-88 degrees.

7. The tire of claim 1 wherein the barrier ply has a first end that terminates axially inward of the narrowest belt axially outer end a distance Z as measured from the axially outermost belt edge, wherein Z ranges from (0.1 to 0.25)*Bw, wherein Bw is the maximum belt width.

8. The tire of claim 1 wherein at least one outer ply has a terminal end located in zone B.

9. The pneumatic tire of claim 1 wherein the radial carcass ply cord fiber is nylon.
